(19) United States
(12) Patent Application Publication
(10) Pub. No.: US 2019/0123849 A1
(43) Pub. Date: Apr. 25, 2019

(54) TRANSMITTER, A RECEIVER AND RESPECTIVE METHODS PERFORMED THEREBY FOR COMMUNICATING WITH EACH OTHER

(71) Applicant: Telefonaktiebolaget LM Ericsson (publ), Stockholm (SE)

(72) Inventors: Robert BALDEMAIR, Solna (SE); Karl WERNER, Segeltorp (SE)

(21) Appl. No.: 16/098,768

(22) PCT Filed: May 4, 2016
(86) PCT No.: PCT/SE2016/050408

§ 371 Date: Nov. 2, 2018

(51) Int. Cl. H04L 1/00

(52) U.S. Cl. CPC H04L 1/0003; H04L 1/0028; H04L 1/0009

(57) ABSTRACT

A method (100) performed by a transmitter for performing a transmission to a receiver in a wireless communication network is provided. The method (100) comprises determining (110) a first set and a second set of coding and/or modulation parameters, and transmitting (120) information to the receiver at least about the determined first set of coding and/or modulation parameters. The method (100) further comprises transmitting (130) a transmission comprising a first set of code blocks, which have been encoded and/or modulated using the first set of coding and/or modulation parameters and a second set of code blocks, which have been encoded and/or modulated using the second set of coding and/or modulation parameters.

### TECHNICAL FIELD

The present disclosure relates to wireless communication and in particular to a transmitter and a receiver in a wireless communication network.

### BACKGROUND

Modern wireless communications systems organize their resource along the time axis in subframes. A subframe is the time duration of a basic building block at the physical layer. In e.g. Orthogonal Frequency Division Multiplexing, OFDM, a subframe comprises a number of OFDM symbols. Some of the resource elements (one subcarrier of one OFDM symbols) carry reference signals which enable channel estimation at the receiver. A transmitter performs a transmission to the receiver. In Long Term Evolution for example, once the receiver has received the majority of transmission, e.g. a most parts of the subframe, the receiver may start to decode and/demodulate the received transmission.

In current radio communication systems, e.g. 3^{rd} Generation Partnership Project, 3GPP, for the Long Term Evolution system, LTE, a delay may be necessary for decoding a subframe, the delay being the time to receive the majority of subframes. Once the majority of subframes are received, the receiver may decode it.

In coming radio communication systems, also referred to as 5G, early decoding may be an option, wherein the receiver may want to start decoding as soon as a code block or maybe even only part of a code block, being a part of the subframe, is received. This requires at least a first reference signal being present at the very beginning of the subframe.

The information bits to be transmitted within the subframe are typically encoded to improve transmission robustness. The information bits, also referred to as the data or data information, put to the physical layer for transmission are often denoted a transport block. In modern communication systems a transport block may be very large, e.g. in LTE Rel. 12 the largest transport block size is almost 400 kbit. This is a much larger block than the channel encoding is done for, e.g. in LTE the largest code block size is around 6 kbit. Therefore one transport block may consist of multiple code blocks. Feedback to the receiver if a transmission has been successful is based on the complete transport block. If only a single feedback bit is used the decoding status (successful=1/failure=0) of all individual code blocks constituting the transport block is logical AND combined and transmitted. Rich feedback could also be envisioned where a few bits (but much fewer than code blocks) are used to encode the feedback.

In addition to early reference signals it is also important that code blocks are not unnecessarily spread in time but localised in time, otherwise decoding could only start after the last coded bit of the code block has been received or at least decoding would rather soon get stuck.

In case a code block of the transport block is not successfully received, the whole transport block may be lost. In case an exaggerated level of coding and/or modulation has been used, the whole transport block has been sent with too much resources.

### SUMMARY

The object is to obviate at least some of the problems outlined above. In particular, it is an object to provide a transmitter and a receiver and a respective method performed thereby for communicating with each other. These objects and others may be obtained by providing a transmitter and a receiver as well as a method performed by a transmitter and a receiver according to the independent claims attached below.

According to an aspect, a method performed by a transmitter in a wireless communication network for performing a transmission to a receiver is provided. The method comprises determining a first set and a second set of coding and/or modulation parameters, and transmitting information to the receiver at least about the determined first set of coding and/or modulation parameters. The method further comprises transmitting a transmission comprising a first set of code blocks, which have been encoded and/or modulated using the first set of coding and/or modulation parameters and a second set of code blocks, which have been encoded and/or modulated using the second set of coding and/or modulation parameters.

According to an aspect, a method performed by a receiver in a wireless communication network for receiving a transmission from a transmitter is provided. The method comprises receiving, from the transmitter, information about at least a first set of coding and/or modulation parameters; receiving a first set of code blocks; and decoding and/or demodulating the first set of code blocks using the first set of coding and/or modulation parameters. The method further comprises receiving a second set of code blocks; and decoding and/or demodulating the second set of code blocks using a second set of coding and/or modulation parameters.

According to an aspect, a transmitter in a wireless communication network for performing a transmission to a receiver is provided. The transmitter is configured for determining a first set and a second set of coding and/or modulation parameters, and transmitting information to the receiver at least about the determined first set of coding and/or modulation parameters. The transmitter is further configured for transmitting a transmission comprising a first set of code blocks, which have been encoded and/or modulated using the first set of coding and/or modulation parameters and a second set of code blocks, which have been encoded and/or modulated using the second set of coding and/or modulation parameters.

According to an aspect, a receiver in a wireless communication network for receiving a transmission from a transmitter is provided. The receiver is configured for receiving, from the transmitter, information about at least a first set of coding and/or modulation parameters; receiving a first set of code blocks; and decoding and/or demodulating the first set of code blocks using the first set of coding and/or modulation parameters. The receiver is further configured for receiving a second set of code blocks; and decoding and/or demodulating the second set of code blocks using a second set of coding and/or modulation parameters.

The method performed by the transmitter, the method performed by the receiver, the transmitter and the receiver have several possible advantages. One possible advantage is that modulation and/or coding parameters associated with code blocks within a transport block may be adopted to achieve approximately the same decoding error rate for each code block constituting the transport block. The adopted modulation parameters may increase data rate (higher code rate, higher order modulation) or lower transmit power for those code blocks that benefit from improved channel estimation and thus would have fewer detection errors with the original set of modulation parameters.

### BRIEF DESCRIPTION OF DRAWINGS

Embodiments will now be described in more detail in relation to the accompanying drawings, in which:

FIG. 1 is a flowchart of a method performed by a transmitter in a wireless communication network for performing a transmission to a receiver, according to an exemplifying embodiment.

FIG. 2a is a flowchart of a method performed by a receiver in a wireless communication network for receiving a transmission from a transmitter, according to an exemplifying embodiment.

FIG. 2b is a flowchart of a method performed by a receiver in a wireless communication network for receiving a transmission from a transmitter, according to yet an exemplifying embodiment.

FIG. 2c is a flowchart of a method performed by a receiver in a wireless communication network for receiving a transmission from a transmitter, according to still an exemplifying embodiment.

FIG. 3a is an illustration of an example of a subframe in an OFDM based communication system.

FIG. 3b is an illustration of another example of a subframe in an OFDM based communication system.

FIG. 3c is an illustration of yet an example of a subframe in an OFDM based communication system.

FIG. 4 is a block diagram of a transmitter configured for performing a transmission to a receiver in a wireless communication network, according to an exemplifying embodiment.

FIG. 5 is a block diagram of a transmitter configured for performing a transmission to a receiver in a wireless communication network, according to another exemplifying embodiment.

FIG. 6 is a block diagram of a receiver in a wireless communication network configured for receiving a transmission from a transmitter, according to an exemplifying embodiment.

FIG. 7 is a block diagram of a receiver in a wireless communication network configured for receiving a transmission from a transmitter, according to another exemplifying embodiment.

FIG. 8 is a block diagram of an arrangement in a transmitter configured for performing a transmission to a receiver in a wireless communication network, according to an exemplifying embodiment.

FIG. 9 is a block diagram of an arrangement in a receiver in a wireless communication network configured for receiving a transmission from a transmitter, according to an exemplifying embodiment.

### DETAILED DESCRIPTION

Briefly described, a method performed by a transmitter and a method performed by a receiver are provided. Likewise, a transmitter and a receiver are provided.

When the transmitter is to transmit information or data to the receiver, the transmitter determines at least two different sets modulation and/or coding parameters for the transmission. The transmission may comprise one or more subframes, which in turn may comprise a plurality of code blocks. The transmission may be one transport block or a part of one transport block. The transmitter uses at least a first set of modulation and/or coding parameters for a first set of code blocks of the transmission and a second set of modulation and/or coding parameters for a second set of code blocks of the transmission. The transmission also comprises at least one reference signal.

The receiver, may then when it receives the transmission, demodulate the first set of code blocks of the transmission using the first set of modulation and/or coding parameters; and demodulate the second set of code blocks of the transmission using the second set of modulation and/or coding parameters.

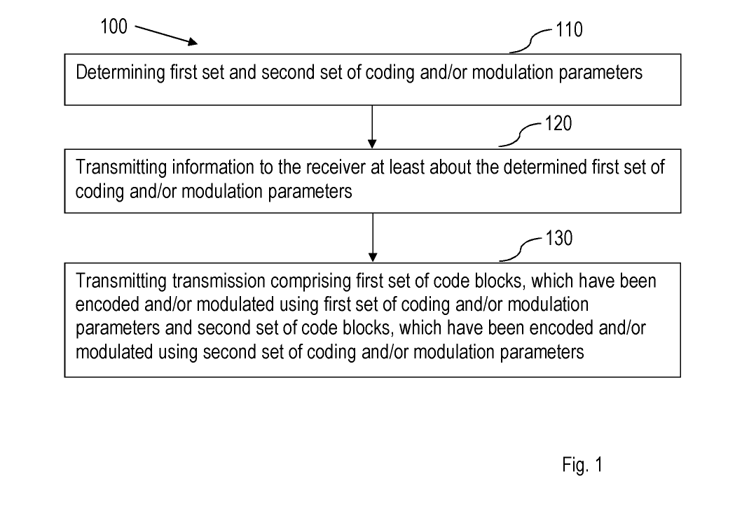

Embodiments of such a method performed by a transmitter in a wireless communication network for performing a transmission to a receiver will now be described with reference to FIG. 1.

FIG. 1 illustrates the method 100 comprising determining 110 a first set and a second set of coding and/or modulation parameters, and transmitting 120 information to the receiver at least about the determined first set of coding and/or modulation parameters. The method 100 further comprises transmitting 130 a transmission comprising a first set of code blocks, which have been encoded and/or modulated using the first set of coding and/or modulation parameters and a second set of code blocks, which have been encoded and/or modulated using the second set of coding and/or modulation parameters.

When the transmitter is to transmit a transmission, the transmitter first determines the first set of coding and/or modulation parameters and the second set of coding and/or modulation parameters. The coding and/or modulation parameters may determine e.g. which Modulation and Coding Scheme, MCS, to use for the transmission. The MCS is used in order to ensure, as satisfactorily as possible, that the transmission will be successfully received at the receiver. The MCS creates a level of robustness, wherein e.g. certain bit errors in the transmission may be corrected. The MCS may also introduce redundancy or extra bits to be transmission in addition to the bits of the data that is to be transmitted to the receiver. The redundancy or the extra bits creates the level of robustness but also reduces the bit rate for “pure data” since the extra bits also needs to be transmitted along with the data. MCS also determines how many bits can be packed into a single symbol; the more bits are packed into a single symbol the higher the data rate but also the lower the reliability. Generally, the more extra bits that are introduced by the MCS, the more robust and reliable the transmission will be, but the more overhead is created thereby reducing the bit rate for “pure data”. The transmitter thus determines the first and the second set of coding and/or modulation parameters in order to assure, as satisfactorily as possible, that the transmission will be successfully received at the receiver but without more overhead, i.e. extra bits, than needed.

Once the transmitter has determined the first and the second set of coding and/or modulation parameters to be used for the upcoming transmission, the transmitter transmits information to the receiver at least about the determined first set of coding and/or modulation parameters. In order for the receiver to successfully decode and/or demodulate a received transmission, it needs to know which coding and/or modulation parameters were used by the transmitter for the transmission. Thus the transmitter informs the receiver about at least the first set of coding and/or modulation parameters. As will be described in more detail below, the transmitter may also inform the receiver about the second set of coding and/or modulation parameters. However, it may not be necessary to inform the receiver about the second set of coding and/or modulation parameters as will be explained.

Once the transmitter has informed the receiver about at least the determined first set of coding and/or modulation parameters, the transmitter transmits the transmission comprising the first set of code blocks, which have been encoded and/or modulated using the first set of coding and/or modulation parameters and the second set of code blocks, which have been encoded and/or modulated using the second set of coding and/or modulation parameters. The transmission may comprise one whole transport block or a part of one whole transport block as will be described in more detail below.

The transmission comprises the first set of code blocks and the second set of code blocks. The transmitter uses the first set of coding and/or modulation parameters to encode and/or modulate the first set of code blocks; and the second set of coding and/or modulation parameters to encode and/or modulate the second set of code blocks. Once the code blocks are encoded and/or modulated, the transmitter may transmit the code blocks, by performing the transmission comprising the first set of code blocks, which have been encoded and/or modulated using the first set of coding and/or modulation parameters and the second set of code blocks, which have been encoded and/or modulated using the second set of coding and/or modulation parameters.

The method performed by the transmitter has several possible advantages. One possible advantage is that modulation and/or coding parameters associated with code blocks within a transport block may be adopted to achieve approximately the same decoding error rate for each code block constituting the transport block. The adopted modulation parameters may increase data rate (higher code rate, higher order modulation) or lower transmit power for those code blocks that benefit from improved channel estimation and thus would have fewer detection errors with the original set of modulation parameters.

The information transmitted to the receiver at least about the determined first set of coding and/or modulation parameters may also comprise information about the second set of coding and/or modulation parameters.

As stated above, the transmitter may also transmit information to the receiver also about the second set of coding and/or modulation parameters. If so, this information may be incorporated into the information transmitted to the receiver at least about the determined first set of coding and/or modulation parameters. In this manner, the transmitter needs only to transmit coding and/or modulation parameter information once, wherein the information comprises information about both the determined first and the second set of coding and/or modulation parameters.

Merely as an example, it may be that once the first set of coding and/or modulation parameters is determined, the second set of coding and/or modulation parameters is given in the way of a predetermined offset between the first and the second set of coding and/or modulation parameters. If so, then there is no need to actively include information about the second set of coding and/or modulation parameters as it is given by the offset in relation to the first second set of coding and/or modulation parameters. However, in another example, the first set of coding and/or modulation parameters and the second set of coding and/or modulation parameters may be determined such that no given relationship between the first and the second set of coding and/or modulation parameters is always present, meaning that the receiver may not know the second set of coding and/or modulation parameters based on the first set of coding and/or modulation parameters. If so, then the transmitter needs to transmit information about both the first and the second set of coding and/or modulation parameters.

The transmission may include at least one reference signal in accordance with a reference signal pattern; wherein the grouping of code blocks into first and second group of code blocks are dependent on the reference signal pattern.

Generally, a transmission comprises at least one subframe, wherein the subframe comprises one or more reference signals. Reference signals may be used, e.g. to perform different measurements and estimation of channel and/or signal quality. Reference signals may also be used e.g. in the process of demodulating and/or decoding a received transmission.

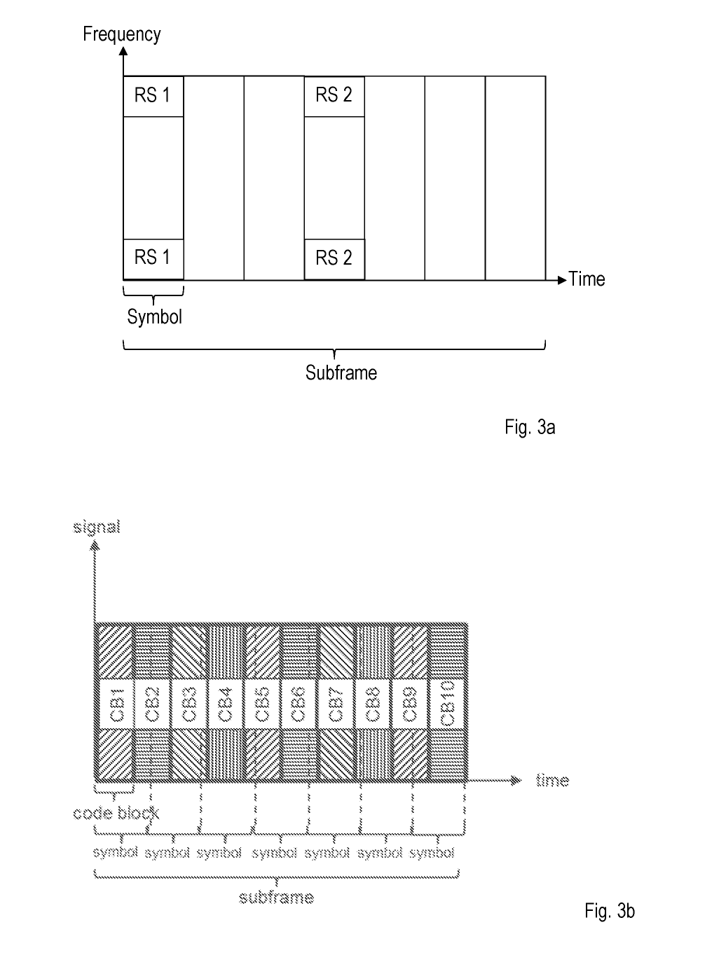

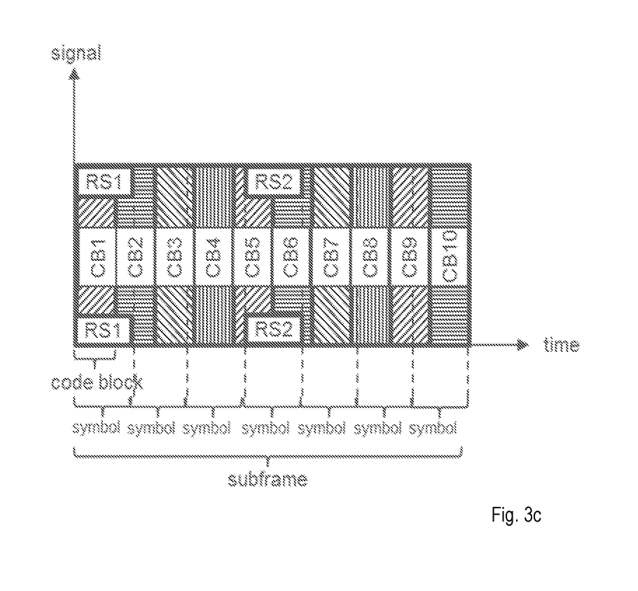

The reference signals may appear in different places of the transmission and the code blocks of the transmission may be grouped together based on the reference signal pattern, i.e. where in the transmission of the reference signal(s) appear. See for example FIGS. 3a-3c, in which an example is illustrated wherein the transmission comprises one subframe having two reference signals and 10 code blocks, CBs. In this specific example, code blocks 1-5 may be grouped into a first set of code blocks associated with the first reference signal, RS 1; and code blocks 6-10 may be grouped into a second set of code blocks associated with the second reference signal, RS 2. In this manner, depending on the reference signals and where in the transmission they appear (i.e. their pattern), the code blocks may be grouped accordingly.

The transmission may correspond to one transport block or a part of one transport block.

The information bits to be transmitted in the transmission are generally put to the physical layer for transmission and the collection of information bits is often denoted a transport block. A transport block may be very large, e.g. in 3GPP LTE, Release 12, the largest transport block size is almost 400 kbit. This is a much larger block than the channel encoding is done for, e.g. in LTE the largest code block size is around 6 kbit. One transport block may consist of multiple code blocks. LTE is an example of a 4^{th} Generation, 4G, radio communication system. In a 5G radio communication system, the transport block may also be large and comprise multiple code blocks.

When information is to be transmitted to the receiver, the transmitter may also expect feedback by an Acknowledgement, ACK, or Negative Acknowledgement, NACK. Feedback from the receiver to the transmitter if a transmission has been successful is generally based on the complete transport block.

The transmission may thus comprise one whole transport block, or a part of one transport block.

The transmission may be scheduled in a single Downlink Control Information, DCI, message.

Generally, e.g. when the transmitter is a network node and the receiver is a wireless device, the wireless device may be informed via DCI which modulation parameters (modulation order, transport block parameters such as transport block size, code rate, etc.) are used for the transmission of the current transmission/transport block. The wireless device needs to know the correct parameters for each (group of) code blocks. This could be enabled by signalling each set of modulation parameters in an extended DCI. Another alternative however is to express the additional modulation parameters as delta information relative to the first modulation and/or coding parameters as described. The delta values could again be signalled in the DCI, they could be configured via high layer signalling (e.g. Radio Resource Control, RRC, signalling), or they could be specified in the standard.

In an example, a first part of the transmission comprises a first reference signal and the first set of code blocks and a second part of the transmission comprises a second reference signal and the second set of code blocks.

By means of the reference signals, the code blocks may be grouped accordingly as described above. Looking at FIG. 3c, the transmission, which in this example comprises one subframe, comprises a first reference signal, RS 1 in the beginning of the subframe followed by code blocks 1-5, which are grouped together based on RS 1 and make up the first group of code blocks. Further, the transmission/subframe comprises a second reference signal RS 2 followed by code blocks 6-10, which are grouped together based on RS 2 and make up the second group of code blocks.

The transmission may comprise one subframe or a plurality of subframes.

As described above, the transmission may comprise one transport block, wherein the transport block comprises one subframe or a plurality of subframes. Depending on the radio communication system, a transmission may be of different size and comprise one or more subframes. For example, assuming the radio communication system is based on OFDM and LTE, a transmission may comprise one subframe, which in turn may comprise two resource blocks. However, OFDM is just an example and not a limitation. The method applies to every transmission scheme where multiple code blocks form a transport block.

In case the transmission comprises more than one subframe, then a subframe may comprise, zero, one, or more reference signals since the transmission itself comprises one or more reference signals.

The first set and the second set of coding and/or modulation parameters may be based on an assumed effective channel quality estimation effect at the receiver having one reference signal and having two or more reference signals.

By assuming an effective channel quality estimation effect at the receiver having one reference signal and having two or more reference signals, the transmitter may determine the first set and the second set of coding and/or modulation parameters based on that assumption.

When the receiver receives the first reference signal, the receiver may perform measurements and estimations of the effective channel based on the received first reference signals. When the receiver receives the second reference signal, the receiver may use both the first and the second received reference signal thereby accomplishing a more accurate effective channel estimate. The set of useable reference signals may also depend on whether early decoding or not is used, wherein early decoding starts as soon as the first reference signal is received.

Code rate and/or other modulation parameters (e.g. modulation order) of code blocks constituting a transport block are usually not constant but set according to expected decoding performance, which is determined, for example, based on expected channel estimate quality. The expected channel estimation quality varies since for early code blocks the channel estimate during decoding is only based on the first reference signal while for later code blocks (code blocks transmitted after a new reference signal) an improved channel estimate based on first and second reference signal can be used for decoding. Another reason for varying channel estimate quality across code blocks is Doppler spread: In high Doppler scenarios, the effective channel for code blocks transmitted late in the transmission may differ from the effective channel for the reference signal transmission.

The second set of coding and/or modulation parameters may be associated with a higher rate than the first set of coding and/or modulation parameters.

The effective channel quality (including channel estimate performance, Signal to Noise Ration, SNR, and other factors) will vary across the transmission in a way that may be partly predicted. The modulation and/or coding parameters may thus be varied across the code blocks to match the varying effective channel quality.

Since it may be assumed that the estimations of the effective channel may be more accurate based on two reference signals than based on only one, the second set of coding and/or modulation parameters may be associated with a higher rate than the first set of coding and/or modulation parameters.

In an example, the transmitting 120 of information comprises transmitting the actual determined first set and second set of coding and/or modulation parameters.

There are different ways to transmit the information about the determined first set and second set of coding and/or modulation parameters. As described above, the second set of coding and/or modulation parameters may be related to the first set of coding and/or modulation parameters by an offset. If so, it may not be necessary to transmit explicit information about the second set of coding and/or modulation parameters since the receiver may determine the second set of coding and/or modulation parameters by adding the offset to the first set of coding and/or modulation parameters.

However, if the first and the second set of coding and/or modulation parameters are not dependent on each other so that the second set of coding and/or modulation parameters cannot be determined based on knowledge of the first set of coding and/or modulation parameters, then the transmitter needs to transmit explicit information about both the first and the second set of coding and/or modulation parameters.

In another example, the transmitting 120 of information comprises transmitting the determined first set of coding and/or modulation parameters and an offset, wherein the offset is representative of a difference between the determined first set and second set of coding and/or modulation parameters.

This is another example of transmitting information about the determined first and second set of coding and/or modulation parameters. In this example, the first and the second set of coding and/or modulation parameters need not be dependent on each other such that the offset is predetermined. It may be that the transmitter determines the offset and thus transmits the determined first set of coding and/or modulation parameters and the offset.

In this manner, the receiver receives the determined first set of coding and/or modulation parameters and the offset and may determine the second set of coding and/or modulation parameters accordingly using the offset and the first set of coding and/or modulation parameters.

In yet another example, the transmitting 120 of information comprises transmitting DCI message comprising the information about the determined first set and/or second set of coding and/or modulation parameters.

In this example, for example an extended DCI may be used to carry the information about the determined first set and/or second set of coding and/or modulation parameters.

Also in case the second set of coding and/or modulation parameters can be determined based in the first set of coding and/or modulation parameters and the offset, the transmitter may transmit the first set of coding and/or modulation parameters and the offset in an extended DCI message to the receiver.

In still another example, the transmitting 120 of information comprises transmitting Radio Resource Control, RRC, information comprising the information about the determined first set and/or second set of coding and/or modulation parameters.

In this example, the RRC information comprises the information about the determined first set and/or second set of coding and/or modulation parameters. For example, the RRC information may be used for transmitting information about both the first and the second set of coding and/or modulation parameters; for transmitting the first or the second set of coding and/or modulation parameters; or for transmitting the first set of coding and/or modulation parameters and/or the offset.

RRC signalling is generally used by so-called higher layers. The major functions of the RRC protocol include connection establishment and release functions, broadcast of system information, radio bearer establishment, reconfiguration and release, RRC connection mobility procedures, paging notification and release and outer loop power control. By means of the signalling functions the RRC configures the user and control planes according to the network status and allows for Radio Resource Management, RRM, strategies to be implemented.

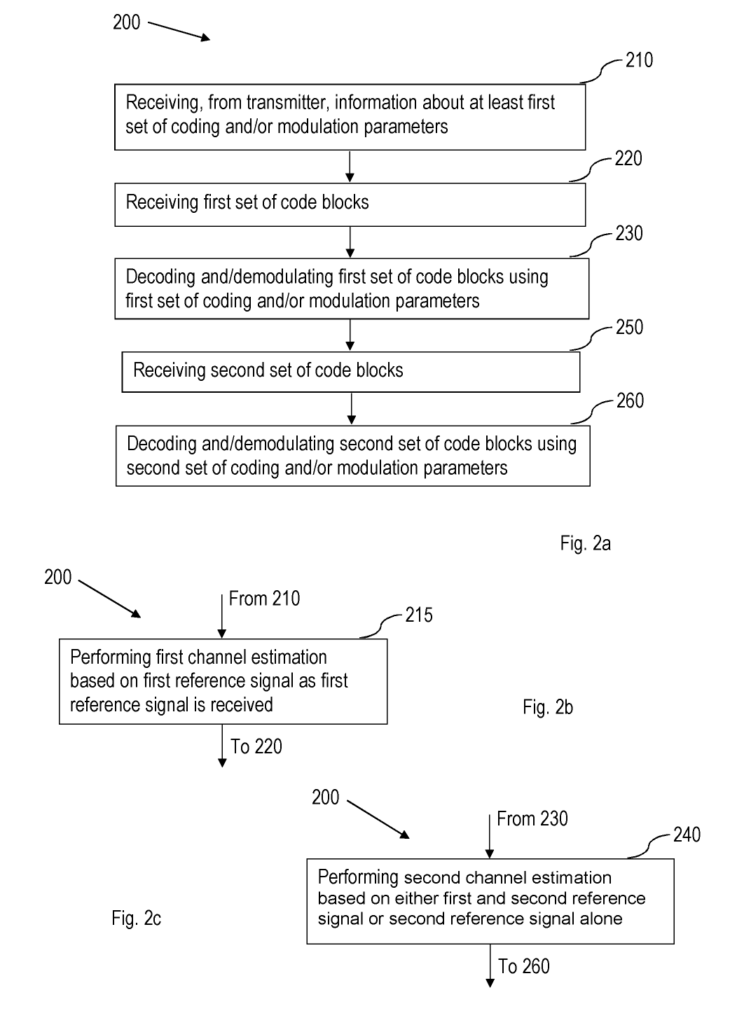

Embodiments herein also relate to a method performed by a receiver in a wireless communication network for receiving a transmission from a transmitter. Embodiments of such a method will now be described with reference to FIGS. 2a-2c.

FIG. 2a illustrates the method 200 comprising receiving 210, from the transmitter, information about at least a first set of coding and/or modulation parameters; receiving 220 a first set of code blocks; and decoding and/or demodulating 230 the first set of code blocks using the first set of coding and/or modulation parameters. The method further comprises receiving 250 a second set of code blocks; and decoding and/or demodulating 260 the second set of code blocks using a second set of coding and/or modulation parameters.

When receiver is about to receive a transmission from the transmitter, the receiver needs to know the coding and/or modulation parameters that have been used by the transmitter to perform the transmission. This is in order for the receiver to correctly demodulate and/or decode the received transmission. Consequently, the receiver first receives information about at least the first set of coding and/or modulation parameters. As has been explained above, the second set of coding and/or modulation parameters may possibly be determined by the receiver based on the first set of coding and/or modulation parameters and an offset. Hence, information about the determined second set of coding and/or modulation parameters may possibly not need to be explicitly received.

The receiver also receives the first set of code blocks and may decode and/or demodulate the first set of code blocks using the first set of coding and/or modulation parameter. The decoding and/or demodulation may be performed as soon as the first code block is received and may potentially even start after parts of the first code block has been received. Thus it may not be necessary to wait for all code blocks in the first set of code blocks before the receiver starts decoding and/or demodulation them.

The receiver also receives the second set of code blocks, and decodes and/or demodulates the second set of code blocks using the second set of coding and/or modulation parameters. As has been described above, information about the second set of coding and/or modulation parameters may have been received before or the second set of coding and/or modulation parameters may be determined based on the received first set of coding and/or modulation parameters and an offset. The offset may have been received together or at separate occasion with the information about the first set of coding and/or modulation parameters. Alternatively, the offset may be predetermined and hardcoded into the receiver. It is pointed out that the first set of coding and/or modulation parameters should be received/determined before decoding of first set of code blocks.

The method performed by the receiver has the same several possible advantages as the method performed by the transmitter. One possible advantage is that modulation and/or coding parameters associated with code blocks within a transport block may be adopted to achieve approximately the same decoding error rate for each code block constituting the transport block. The adopted modulation parameters may increase data rate (higher code rate, higher order modulation) or lower transmit power for those code blocks that benefit from improved channel estimation and thus would have fewer detection errors with the original set of modulation parameters.

The information about the second set of coding and/or modulation parameters may be (a) comprised in the received information about the first set of coding and/or modulation parameters, or (b) pre-stored in the receiver by an offset with regard to the first set of coding and/or modulation parameters.

There are several options for the receiver to obtain the second set of coding and/or modulation parameters as described above.

In alternative (a), explicit information about the second set of coding and/or modulation parameters may be received together with the information about the first set of coding and/or modulation parameters. In alternative (b), the second set of coding and/or modulation parameters are dependent on the first set of coding and/or modulation parameters, wherein they are “separated” by an offset. The second set of coding and/or modulation parameters may then be determined by the receiver based on the first set of coding and/or modulation parameters and the offset.

The transmission may include at least one reference signal according to a reference signal pattern, wherein the receiver determines the reference signal pattern; wherein the receiver uses the reference signal pattern to determine the grouping of code blocks into first and second group of code blocks.

As described above, a transmission comprises at least one subframe, wherein the subframe comprises one or more reference signals. Reference signals may be used, e.g. to perform different measurements and estimation of channel and/or signal quality. Reference signals may also be used e.g. in the process of demodulating and/or decoding a received transmission.

The reference signals may appear in different places of the transmission and the code blocks of the transmission may be grouped together based on the reference signal pattern.

Determining the reference signal pattern may comprise receiving information about the reference signal pattern from the transmitter.

In order to determine the reference signal pattern, the transmitter may transmit information to the receiver about the reference signal pattern it intends to use for the transmission.

In this manner, the receiver will receive information from the transmitter about the reference signal pattern, wherein the receiver will know which parts of the transmission will comprise data information and which parts of the transmission will comprise reference signals.

The transmission may, as described above, correspond to one transport block or a part of one transport block.

The transmission may be scheduled in a single DCI message.

Also as described above, the receiver may be informed via DCI which modulation parameters (modulation order, transport block parameters such as transport block size, code rate, etc.) are used for the transmission of the current transmission/transport block. The receiver needs to know the correct parameters for each (group of) code blocks. This is enabled e.g. by signalling each set of modulation parameters in an extended DCI, wherein the DCI comprises information about a scheduled transmission.

In an example, a first part of the transmission comprises a first reference signal and the first set of code blocks and a second part of the transmission comprises a second reference signal and the second set of code blocks.

The first reference signal is generally comprised early in the transmission so that the receiver may start demodulate and/or decode the transmission, i.e. the code blocks thereof, directly upon reception of the first reference signal. Using the first reference signal, the receiver may perform an estimation of effective channel, which together with the first set of coding and/or modulation parameters the receiver may use in order to decode the following first set of code blocks. Once the receiver receives the second reference signal, the receiver may perform an estimation of effective channel, which together with the second set of coding and/or modulation parameters the receiver may use to demodulate and/or decode the following second set of code blocks.

It shall be pointed out, also schematically illustrated in FIG. 3c, that may not be a “fine line” or division between the code blocks and reference signals. As schematically illustrated in FIG. 3c, the second reference signal overlaps both code block 5 and code block 6. Thus, it may be that code block 6 may demodulated and/or decoded using the first set of modulation and/or coding parameters, wherein code block 6 may belong to the first set of code blocks even though it is partly received after the second reference signal.

The method may further comprise, as illustrated in FIG. 2b, performing 215 a first channel estimation based on the first reference signal as the first reference signal is received.

When the first reference signal is received, the receiver may use the first reference signal to perform the first channel estimation. The receiver may measure received signal strength and/or other parameters in order to perform the first channel estimation.

In an example, the decoding and/or demodulating 230 of the first set of code blocks is performed also using the first channel estimate.

The receiver may use the first channel estimate in order to decode and/or demodulate of the first set of code blocks. The decoding and/or demodulating may comprise normalising the channel, wherein the first channel estimate may be used to normalise the channel.

The method may further comprise performing 240 a second channel estimation based on either the first and the second reference signal or the second reference signal alone.

The second channel estimate may be based on both the first and the second reference signal. This may improve channel estimation by averaging or filtering the first and the second reference signal.

Alternatively, the second channel estimate may be based on the second reference signal only, which may be more representative of the current channel quality as channel conditions may have changed from the time when the first reference signal was received.

By basing the second channel estimate on either only the second reference signal or on both the first and the second reference signal, an improved and more accurate channel estimation may be obtained.

The decoding and/or demodulating 260 of the second set of code blocks may be performed also using the second channel estimate.

Just as described above, the receiver may use the second channel estimate in order to decode and/or demodulate of the second set of code blocks. The decoding and/or demodulating may comprise normalising the channel, wherein the second channel estimate may be used to normalise the channel.

The transmission may comprise one subframe or a plurality of subframes.

As explained above, the transmission may comprise one transport block, wherein the transport block comprises one subframe or a plurality of subframes. Depending on the radio communication system, a transmission may be of different size and comprise one or more subframes.

In case the transmission comprises more than one subframe, then a subframe may comprise, zero, one, or more reference signals since the transmission itself comprises one or more reference signals.

In an example, the transport block comprises one or more transmissions, wherein a transmission comprises one or more subframes, wherein code blocks are grouped in association with reference signal pattern.

The transport block may be transmitted in one transmission if its size and the radio communication system so allows. Alternatively, the transport block may be transmitted in two or more separate transmissions, wherein a transmission comprises a part of the transport block.

Also as described above, the transmission may comprise one or more subframes.

The reference signals may appear in different places of the transmission and the code blocks of the transmission may be grouped together based on the reference signal pattern, i.e. where in the transmission the reference signal(s) appear.

The receiving 210 of, from the transmitter, information about a first set and a second set of coding and/or modulation parameters may comprise receiving a DCI message comprising the information about the determined first set and second set of coding and/or modulation parameters.

There are different ways for the receiver to receive the information about the first and the second set of coding and/or modulation parameters as explained above. One alternative comprises, as explained above, to receive a DCI message, e.g. an extended DCI comprising for example scheduling information and information about the determined first set and second set of coding and/or modulation parameters.

In an example, the receiving 210 of, from the transmitter, information about a first set and a second set of coding and/or modulation parameters comprises receiving Radio Resource Control, RRC, information comprising the information about the determined first set and/or second set of coding and/or modulation parameters.

This is another example of receiving the information, which is also described above.

The second coding and/or modulation parameters may be the first coding and/or modulation parameters combined with offset.

As described above, the offset may be predefined and/or hardcoded into the receiver. The offset may alternatively be determined by the transmitter, wherein the transmitter transmits information to the receiver about the determined first set of coding and/or modulation parameters and the offset.

Regardless of how the receiver obtains the offset, the receiver may determine the second set of coding and/or modulation parameters based on the first set of coding and/or modulation parameters and the obtained offset.

FIGS. 3a-3c are illustrations of an example of a subframe comprising 7 symbols, the symbols e.g. being OFDM symbols. The subframe also comprises two reference signals, RS 1 and RS 2 as illustrated in FIG. 3a. In this illustrative example, the transport block comprises the subframe, wherein the transport block comprises 10 code blocks as illustrated in FIG. 3b. The method performed by the transmitter and the method performed by the receiver adopts modulation and/or coding parameters associated with code blocks within a transport block to achieve approximately the same decoding error rate for each code block constituting the transport block. The adopted modulation parameters may increase data rate (higher code rate, higher order modulation) or lower transmit power for those code blocks that benefit from improved channel estimation (and thus would have fewer detection errors with the original set of modulation parameters).

In FIG. 3c, code blocks 1 to 6 may be decoded using channel estimate based on reference signal RS1 only since no other reference signal has been yet transmitted

Partly overlapping with transmission of code block 6 a second reference signal is transmitted, RS 2. Channel estimation may be improved by averaging/filtering RS1 and RS2. This new and improved channel estimate may be used for decoding code block 7 and later. If the same coding and modulation parameters as used for code blocks 1 to 6 would be used, the likelihood of erroneous detection of code block 7 would be lower than for code blocks 1 to 6 due to improved channel estimate. However, since only a single (few) bits are used to feedback the decoding status of the transport block the weakest link (code block) determines the overall coding success; improving the decoding performance of some code blocks does not improve overall performance.

The improved channel estimate used for decoding of code block 7 and later should therefore not be used to reduce decoding errors but to increase data rate while maintaining the same decoding error rate as for code blocks 1 to 6. Data rate is improved by using higher code rates or higher order modulations for code blocks 7 and later. Alternatively, the resources, e.g. power, bandwidth, could be reduced for transmission of code blocks 7 and later while maintaining the decoding error rate the same as for code blocks 1 to 6. This approach does not increase data rate but saves transmission resources.

In systems supporting early decoding, one consideration could be to place the second reference signal quite early (earlier than e.g. predicted by channel coherence time) to get an improved channel estimate rather early and enable higher data rates and/or reduced resource consumption as early as possible in the subframe/transmission.

In an example, the respective method may be activated/deactivated, e.g. via higher layer signalling. However, in high Doppler environments, short channel coherence time, the channel may change too much between first and second reference signal transmission thus preventing combining the channel estimates obtained from different reference signals.

The grouping of code blocks may be based on predefined rules set by higher layers or set in the standard. The grouping may be determined by, e.g. reference signal configuration/pattern, number of code blocks in a transport block, position of code blocks in the resource grid etc.

The respective method is described herein in an example having a first set of modulation parameters used for a first group of code blocks and a second set of modulation parameters used for a second group of code words, assuming two reference signals. This may easily be extended to more than two groups of code words and reference signals and to the case of different number of groups of code words and reference signals. Further, minor variations of modulation parameters are even possible within a group of code words (e.g. due to puncturing), however, these changes are not due to expected channel estimation quality differences.

In should be noted, that the channel estimate quality variation across code blocks may not depend only on whether the code block was received before or after the second set of reference signals. In certain scenarios, the channel estimate quality may, in addition, degrade, e.g. as a function of the time elapsed since the latest reference signal transmission (due to Doppler). Hence modulation parameter adjustment for the code blocks based on its position in the resource grid may be based on many factors. One such factor may be interference situation: if control signalling in neighbouring cells occur in a fixed set of OFDM symbols, then inter cell interference may differ across OFDM symbols (and hence code blocks). However, the code blocks of a transport block are given different modulation parameters based on a prediction of the decoding performance given the position of the code block in the resource grid.

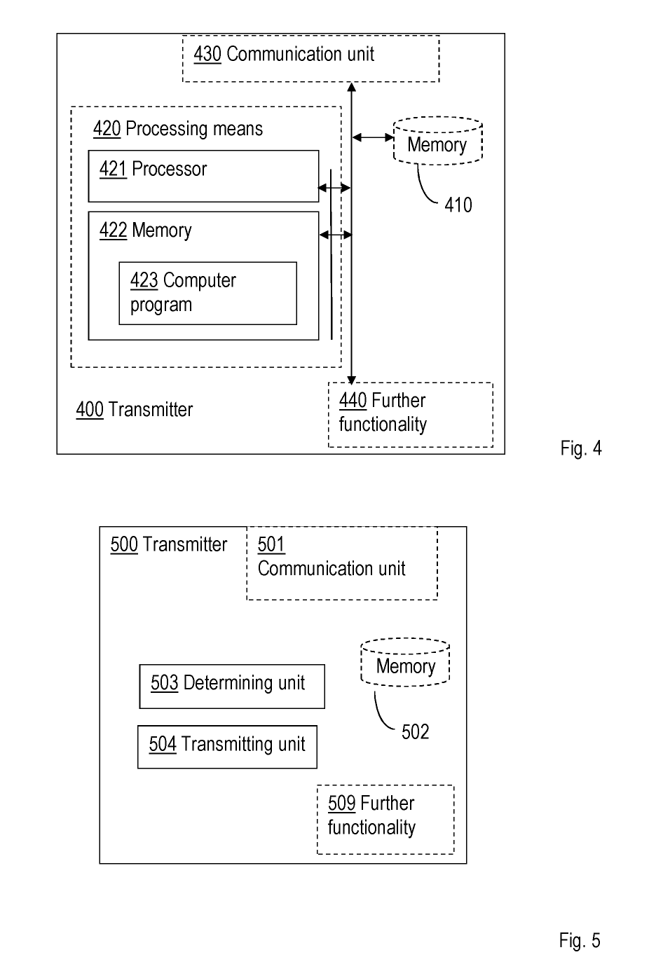

Embodiments herein also relate to a transmitter in a wireless communication network for performing a transmission to a receiver. The transmitter has the same objects, technical features and advantages as the method performed by the transmitter. The transmitter will thus only be described in brief in order to avoid unnecessary repetition. The transmitter will be described with reference to FIGS. 4 and 5.

FIGS. 4 and 5 illustrate the transmitter 400, 500 being configured for determining a first set and a second set of coding and/or modulation parameters, and transmitting information to the receiver at least about the determined first set of coding and/or modulation parameters. The transmitter 400, 500 is further configured for transmitting a transmission comprising a first set of code blocks, which have been encoded and/or modulated using the first set of coding and/or modulation parameters and a second set of code blocks, which have been encoded and/or modulated using the second set of coding and/or modulation parameters.

The transmitter 400, 500 may be implemented or realised in various ways. A first exemplifying implementation or realisation is illustrated in FIG. 4. FIG. 4 illustrates the transmitter 400 comprising a processor 421 and memory 422, the memory comprising instructions, e.g. by means of a computer program 423, which when executed by the processor 421 causes the transmitter 400 to determine a first set and a second set of coding and/or modulation parameters, and to transmit information to the receiver at least about the determined first set of coding and/or modulation parameters. The memory 422 further comprises instructions, which when executed by the processor 421 causes the transmitter 400 to transmit a transmission comprising a first set of code blocks, which have been encoded and/or modulated using the first set of coding and/or modulation parameters and a second set of code blocks, which have been encoded and/or modulated using the second set of coding and/or modulation parameters.

FIG. 4 also illustrates the transmitter 400 comprising a memory 410. It shall be pointed out that FIG. 4 is merely an exemplifying illustration and memory 410 may be optional, be a part of the memory 422 or be a further memory of the transmitter 400. The memory may for example comprise information relating to the transmitter 400, to statistics of operation of the transmitter 400, just to give a couple of illustrating examples. FIG. 4 further illustrates the transmitter 400 comprising processing means 420, which comprises the memory 422 and the processor 421. Still further, FIG. 4 illustrates the transmitter 400 comprising a communication unit 430. The communication unit 430 may comprise an interface through which the transmitter 400 communicates with other nodes or entities of the communication network as well as other communication units. FIG. 4 also illustrates the transmitter 400 comprising further functionality 440. The further functionality 440 may comprise hardware of software necessary for the transmitter 400 to perform different tasks that are not disclosed herein.

An alternative exemplifying implementation of the transmitter 400, 500 is illustrated in FIG. 5. FIG. 5 illustrates the transmitter 500 comprising a determining unit 503 for determining a first set and a second set of coding and/or modulation parameters. FIG. 5 illustrates the transmitter 500 comprising a transmitting unit 504 for transmitting information to the receiver at least about the determined first set of coding and/or modulation parameters; and for transmitting a transmission comprising a first set of code blocks, which have been encoded and/or modulated using the first set of coding and/or modulation parameters and a second set of code blocks, which have been encoded and/or modulated using the second set of coding and/or modulation parameters.

In FIG. 5, the transmitter 500 is also illustrated comprising a communication unit 501. Through this unit, the transmitter 500 is adapted to communicate with other nodes and/or entities in the wireless communication network. The communication unit 501 may comprise more than one receiving arrangement. For example, the communication unit 501 may be connected to both a wire and an antenna, by means of which the transmitter 500 is enabled to communicate with other nodes and/or entities in the wireless communication network. Similarly, the communication unit 501 may comprise more than one transmitting arrangement, which in turn is connected to both a wire and an antenna, by means of which the transmitter 500 is enabled to communicate with other nodes and/or entities in the wireless communication network. The transmitter 500 is further illustrated comprising a memory 502 for storing data. Further, the transmitter 500 may comprise a control or processing unit (not shown) which in turn is connected to the different units 503-504. It shall be pointed out that this is merely an illustrative example and the transmitter 500 may comprise more, less or other units or modules which execute the functions of the transmitter 500 in the same manner as the units illustrated in FIG. 5. FIG. 5 also illustrates the transmitter 500 comprising further functionality 509. The further functionality 509 may comprise hardware of software necessary for the transmitter 500 to perform different tasks that are not disclosed herein.

It should be noted that FIG. 5 merely illustrates various functional units in the transmitter 500 in a logical sense. The functions in practice may be implemented using any suitable software and hardware means/circuits etc. Thus, the embodiments are generally not limited to the shown structures of the transmitter 500 and the functional units. Hence, the previously described exemplary embodiments may be realised in many ways. For example, one embodiment includes a computer-readable medium having instructions stored thereon that are executable by the control or processing unit for executing the method steps in the transmitter 500. The instructions executable by the computing system and stored on the computer-readable medium perform the method steps of the transmitter 500 as set forth in the claims.

The transmitter has the same possible advantages as the method performed by the transmitter. One possible advantage is that modulation and/or coding parameters associated with code blocks within a transport block may be adopted to achieve approximately the same decoding error rate for each code block constituting the transport block. The adopted modulation parameters may increase data rate (higher code rate, higher order modulation) or lower transmit power for those code blocks that benefit from improved channel estimation and thus would have fewer detection errors with the original set of modulation parameters.

According to an embodiment, the information transmitted to the receiver at least about the determined first set of coding and/or modulation parameters also comprises information about the second set of coding and/or modulation parameters.

According to yet an embodiment, the transmission includes at least one reference signal in accordance with a reference signal pattern; wherein the grouping of code blocks into first and second group of code blocks are dependent on the reference signal pattern.

According to still an embodiment, the transmission corresponds to one transport block or a part of one transport block.

According to another embodiment, wherein the transmission is scheduled in a DCI message.

According to an embodiment, a first part of the transmission comprises a first reference signal and the first set of code blocks and a second part of the transmission comprises a second reference signal and the second set of code blocks.

According to yet an embodiment, the transmission comprises one subframe or a plurality of subframes.

According to still an embodiment, the first set and the second set of coding and/or modulation parameters are based on an assumed effective channel quality estimation effect at the receiver having one reference signal and having two or more reference signals.

According to another embodiment, the second set of coding and/or modulation parameters are associated with a higher rate than the first set of coding and/or modulation parameters.

According to an embodiment, the transmitter 400, 500 is configured for transmitting of information by transmitting the actual determined first set and second set of coding and/or modulation parameters.

According to yet an embodiment, the transmitter 400, 500 is configured for transmitting of information by transmitting the determined first set of coding and/or modulation parameters and an offset, wherein the offset is representative of a difference between the determined first set and second set of coding and/or modulation parameters.

According to still an embodiment, the transmitter 400, 500 is configured for transmitting of information by transmitting DCI message comprising the information about the determined first set and/or second set of coding and/or modulation parameters.

According to another embodiment, the transmitter 400, 500 is configured for transmitting of information by transmitting RRC information comprising the information about the determined first set and/or second set of coding and/or modulation parameters.

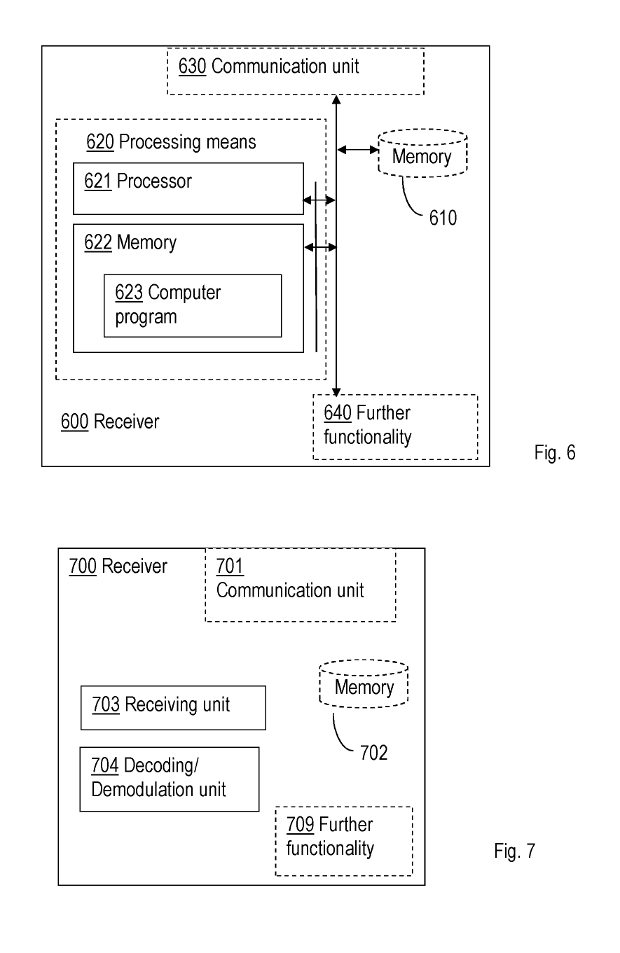

Embodiments herein also relate to a receiver in a wireless communication network for receiving a transmission from a transmitter. The receiver has the same objects, technical features and advantages as the method performed by the receiver. The receiver will thus only be described in brief in order to avoid unnecessary repetition. The receiver will be described with reference to FIGS. 6 and 7.

FIGS. 6 and 7 illustrate the receiver 600, 700 being configured for receiving, from the transmitter, information about at least a first set of coding and/or modulation parameters; receiving a first set of code blocks; and decoding and/or demodulating the first set of code blocks using the first set of coding and/or modulation parameters. The receiver 600, 700 is further configured for receiving a second set of code blocks; and decoding and/or demodulating the second set of code blocks using a second set of coding and/or modulation parameters.

The receiver 600, 700 may be implemented or realised in various ways. A first exemplifying implementation or realisation is illustrated in FIG. 6. FIG. 6 illustrates the receiver 600 comprising a processor 621 and memory 622, the memory comprising instructions, e.g. by means of a computer program 623, which when executed by the processor 621 causes the receiver 600 to receive, from the transmitter, information about at least a first set of coding and/or modulation parameters; and receiving a first set of code blocks. The memory 622 further comprises instructions, which when executed by the processor 621 causes the receiver 600 to decode and/or demodulate the first set of code blocks using the first set of coding and/or modulation parameters. Still further, the memory 622 comprises instructions, which when executed by the processor 621 causes the receiver 600 to receive a second set of code blocks; and to decode and/or demodulate the second set of code blocks using a second set of coding and/or modulation parameters.

FIG. 6 also illustrates the receiver 600 comprising a memory 610. It shall be pointed out that FIG. 6 is merely an exemplifying illustration and memory 610 may be optional, be a part of the memory 622 or be a further memory of the receiver 600. The memory may for example comprise information relating to the receiver 600, to statistics of operation of the receiver 600, just to give a couple of illustrating examples. FIG. 6 further illustrates the receiver 600 comprising processing means 620, which comprises the memory 622 and the processor 621. Still further, FIG. 6 illustrates the receiver 600 comprising a communication unit 630. The communication unit 630 may comprise an interface through which the receiver 600 communicates with other nodes or entities of the communication network as well as other communication units. FIG. 6 also illustrates the receiver 600 comprising further functionality 640. The further functionality 640 may comprise hardware of software necessary for the receiver 600 to perform different tasks that are not disclosed herein.

An alternative exemplifying implementation of the receiver 600, 700 is illustrated in FIG. 7. FIG. 7 illustrates the receiver 700 comprising a receiving unit 703 for receiving, from the transmitter, information about at least a first set of coding and/or modulation parameters; for receiving a first set of code blocks and for receiving a second set of code blocks. FIG. 7 illustrates the receiver 700 comprising a decoding/demodulation unit 704 for decoding and/or demodulating the first set of code blocks using the first set of coding and/or modulation parameters, and for decoding and/or demodulating the second set of code blocks using a second set of coding and/or modulation parameters.

In FIG. 7, the receiver 700 is also illustrated comprising a communication unit 701. Through this unit, the receiver 700 is adapted to communicate with other nodes and/or entities in the wireless communication network. The communication unit 701 may comprise more than one receiving arrangement. For example, the communication unit 701 may be connected to an antenna, by means of which the receiver 700 is enabled to communicate with other nodes and/or entities in the wireless communication network. Similarly, the communication unit 701 may comprise more than one transmitting arrangement, which in turn is connected to an antenna, by means of which the receiver 700 is enabled to communicate with other nodes and/or entities in the wireless communication network. The receiver 700 is further illustrated comprising a memory 702 for storing data. Further, the receiver 700 may comprise a control or processing unit (not shown) which in turn is connected to the different units 703-704. It shall be pointed out that this is merely an illustrative example and the receiver 700 may comprise more, less or other units or modules which execute the functions of the receiver 700 in the same manner as the units illustrated in FIG. 7. FIG. 7 also illustrates the receiver 700 comprising further functionality 709. The further functionality 709 may comprise hardware of software necessary for the receiver 700 to perform different tasks that are not disclosed herein.

It should be noted that FIG. 7 merely illustrates various functional units in the receiver 700 in a logical sense. The functions in practice may be implemented using any suitable software and hardware means/circuits etc. Thus, the embodiments are generally not limited to the shown structures of the receiver 700 and the functional units. Hence, the previously described exemplary embodiments may be realised in many ways. For example, one embodiment includes a computer-readable medium having instructions stored thereon that are executable by the control or processing unit for executing the method steps in the receiver 700. The instructions executable by the computing system and stored on the computer-readable medium perform the method steps of the receiver 700 as set forth in the claims.

The receiver has the same possible advantages as the method performed by the receiver. One possible advantage is that modulation and/or coding parameters associated with code blocks within a transport block may be adopted to achieve approximately the same decoding error rate for each code block constituting the transport block. The adopted modulation parameters may increase data rate (higher code rate, higher order modulation) or lower transmit power for those code blocks that benefit from improved channel estimation and thus would have fewer detection errors with the original set of modulation parameters.

According to an embodiment, information about the second set of coding and/or modulation parameters is (a) comprised in the received information about the first set of coding and/or modulation parameters, or (b) is pre-stored in the receiver by an offset with regard to the first set of coding and/or modulation parameters.

According to yet an embodiment, the transmission includes at least one reference signal according to a reference signal pattern, wherein the receiver determines the reference signal pattern; wherein the receiver uses the reference signal pattern to determine the grouping of code blocks into first and second group of code blocks.

According to still an embodiment, determining the reference signal pattern comprises receiving information about the reference signal pattern from the transmitter.

According to another embodiment, the transmission corresponds to one transport block or a part of one transport block.

According to a further embodiment, the transmission is scheduled in a single DCI message.

According to an embodiment, a first part of the transmission comprises a first reference signal and the first set of code blocks and a second part of the transmission comprises a second reference signal and the second set of code blocks.

According to yet an embodiment, the receiver 600, 700 is further being configured for performing a first channel estimation based on the first reference signal as the first reference signal is received.

According to still an embodiment, the decoding and/or demodulating of the first set of code blocks is performed also using the first channel estimate.

According to another embodiment, the receiver 600, 700 is further being configured for performing a second channel estimation based on either the first and the second reference signal or the second reference signal alone.

According to a further embodiment, the decoding and/or demodulating of the second set of code blocks is performed also using the second channel estimate.

According to an embodiment, the transmission comprises one subframe or a plurality of subframes.

According to yet an embodiment, the transport block comprises one or more transmissions, wherein a transmission comprises one or more subframes, wherein code blocks are grouped in association with reference signal pattern.

According to still an embodiment, the receiving of, from the transmitter, information about a first set and a second set of coding and/or modulation parameters comprises receiving Downlink Control Information, DCI, message comprising the information about the determined first set and second set of coding and/or modulation parameters.

According to another embodiment, the receiving of, from the transmitter, information about a first set and a second set of coding and/or modulation parameters comprises receiving Radio Resource Control, RRC, information comprising the information about the determined first set and/or second set of coding and/or modulation parameters.

According to a further embodiment, the second coding and/or modulation parameters are first coding and/or modulation parameters combined with offset.

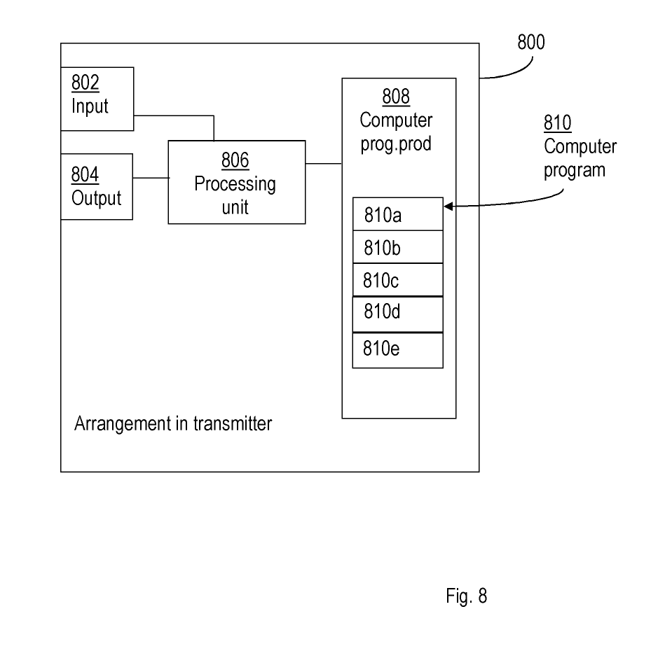

FIG. 8 schematically shows an embodiment of an arrangement 800 in a transmitter 500. Comprised in the arrangement 800 in the transmitter 500 are here a processing unit 806, e.g. with a Digital Signal Processor, DSP. The processing unit 806 may be a single unit or a plurality of units to perform different actions of procedures described herein. The arrangement 800 of the transmitter 500 may also comprise an input unit 802 for receiving signals from other entities, and an output unit 804 for providing signal(s) to other entities. The input unit and the output unit may be arranged as an integrated entity or as illustrated in the example of FIG. 5, as one or more interfaces 501.

Furthermore, the arrangement 800 in the transmitter 500 comprises at least one computer program product 808 in the form of a non-volatile memory, e.g. an Electrically Erasable Programmable Read-Only Memory, EEPROM, a flash memory and a hard drive. The computer program product 808 comprises a computer program 810, which comprises code means, which when executed in the processing unit 806 in the arrangement 800 in the transmitter 500 causes the transmitter to perform the actions e.g. of the procedure described earlier in conjunction with FIG. 1.

The computer program 810 may be configured as a computer program code structured in computer program modules 810a-810e. Hence, in an exemplifying embodiment, the code means in the computer program of the arrangement 800 in the transmitter 500 comprises a determining unit, or module, for determining a first set and a second set of coding and/or modulation parameters. The computer program further comprises a transmitting unit, or module, for transmitting information to the receiver at least about the determined first set of coding and/or modulation parameters, and for transmitting a transmission comprising a first set of code blocks, which have been encoded and/or modulated using the first set of coding and/or modulation parameters and a second set of code blocks, which have been encoded and/or modulated using the second set of coding and/or modulation parameters.

The computer program modules could essentially perform the actions of the flow illustrated in FIG. 1, to emulate the transmitter 500. In other words, when the different computer program modules are executed in the processing unit 806, they may correspond to the units 503-504 of FIG. 5.

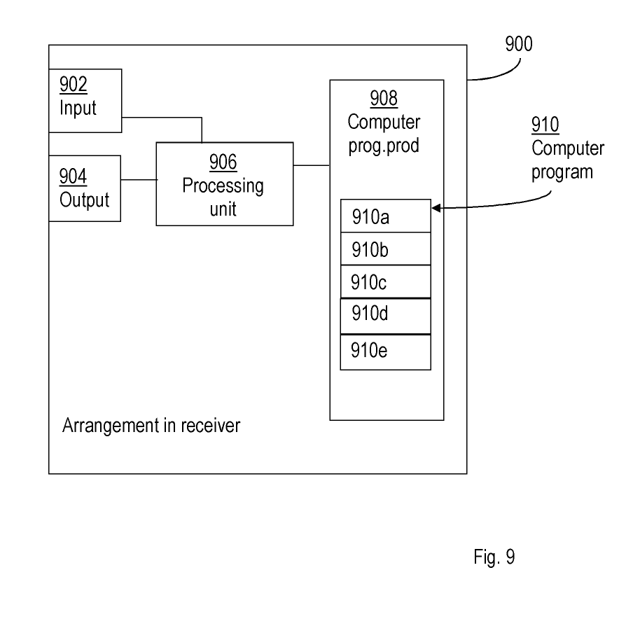

FIG. 9 schematically shows an embodiment of an arrangement 900 in a receiver 700. Comprised in the arrangement 900 in the receiver 700 are here a processing unit 906, e.g. with a DSP. The processing unit 906 may be a single unit or a plurality of units to perform different actions of procedures described herein. The arrangement 900 of the receiver 700 may also comprise an input unit 902 for receiving signals from other entities, and an output unit 904 for providing signal(s) to other entities. The input unit and the output unit may be arranged as an integrated entity or as illustrated in the example of FIG. 7, as one or more interfaces 701.

Furthermore, the arrangement 900 in the receiver 700 comprises at least one computer program product 908 in the form of a non-volatile memory, e.g. an EEPROM, a flash memory and a hard drive. The computer program product 908 comprises a computer program 910, which comprises code means, which when executed in the processing unit 906 in the arrangement 900 in the receiver 700 causes the receiver 700 to perform the actions e.g. of the procedure described earlier in conjunction with FIGS. 2a-2c.

The computer program 910 may be configured as a computer program code structured in computer program modules 910a-910e. Hence, in an exemplifying embodiment, the code means in the computer program of the arrangement 900 in the receiver 700 comprises a receiving unit, or module, for receiving, from the transmitter, information about at least a first set of coding and/or modulation parameters; for receiving a first set of code blocks; and for receiving a second set of code blocks. The computer program further comprises a decoding/demodulation unit, or module, for decoding and/or demodulating the first set of code blocks using the first set of coding and/or modulation parameters; and for decoding and/or demodulating the second set of code blocks using a second set of coding and/or modulation parameters.

The computer program modules could essentially perform the actions of the flow illustrated in FIGS. 2a-2c, to emulate the receiver 700. In other words, when the different computer program modules are executed in the processing unit 906, they may correspond to the units 703-704 of FIG. 7.

Although the code means in the embodiments disclosed above in conjunction with FIGS. 5 and 7 are implemented as computer program modules which when executed in the respective processing unit causes the transmitter and the receiver to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the transmitter and the receiver respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method (100) performed by a transmitter in a wireless communication network for performing a transmission to a receiver, the method comprising:
determining (110) a first set and a second set of coding and/or modulation parameters,
transmitting (120) information to the receiver at least about the determined first set of coding and/or modulation parameters,
transmitting (130) a transmission comprising a first set of code blocks, which have been encoded and/or modulated using the first set of coding and/or modulation parameters and a second set of code blocks, which have been encoded and/or modulated using the second set of coding and/or modulation parameters.

2. The method (100) according to claim 1, wherein the information transmitted to the receiver at least about the determined first set of coding and/or modulation parameters also comprises information about the second set of coding and/or modulation parameters.

3. The method (100) according to claim 1 or 2, wherein the transmission includes at least one reference signal in accordance with a reference signal pattern; wherein the grouping of code blocks into first and second group of code blocks are dependent on the reference signal pattern.

4. The method (100) according to any of claims 1-3, wherein the transmission corresponds to one transport block or a part of one transport block.

5. The method (100) according to any of claims 1-3, wherein the transmission is scheduled in a single Downlink Control Information, DCI, message.

6. The method (100) according to any of claims 1-5, wherein a first part of the transmission comprises a first reference signal and the first set of code blocks and a second part of the transmission comprises a second reference signal and the second set of code blocks.

7. The method (100) according to any of claims 1-6, wherein the transmission comprises one subframe or a plurality of subframes.

8. The method (100) according to any of claims 1-7, wherein the first set and the second set of coding and/or modulation parameters are based on an assumed effective channel quality estimation effect at the receiver having one reference signal and having two or more reference signals.

9. The method (100) according to any of claims 1-8, wherein the second set of coding and/or modulation parameters are associated with a higher rate than the first set of coding and/or modulation parameters.

10. The method (100) according to any of claims 1-9, wherein the transmitting (120) of information comprises transmitting the actual determined first set and second set of coding and/or modulation parameters.

11. The method (100) according to any of claims 1-9, wherein the transmitting (120) of information comprises transmitting the determined first set of coding and/or modulation parameters and an offset, wherein the offset is representative of a difference between the determined first set and second set of coding and/or modulation parameters.

12. The method (100) according to any of claims 1-11, wherein the transmitting (120) of information comprises transmitting Downlink Control Information, DCI, message comprising the information about the determined first set and/or second set of coding and/or modulation parameters.

13. The method (100) according to any of claims 1-11, wherein the transmitting (120) of information comprises transmitting Radio Resource Control, RRC, information comprising the information about the determined first set and/or second set of coding and/or modulation parameters.

14. A method (200) performed by a receiver in a wireless communication network for receiving a transmission, from a transmitter, the method comprising:
receiving (210), from the transmitter, information about at least a first set of coding and/or modulation parameters,
receiving (220) a first set of code blocks,
decoding and/or demodulating (230) the first set of code blocks using the first set of coding and/or modulation parameters,
receiving (250) a second set of code blocks,
decoding and/or demodulating (260) the second set of code blocks using a second set of coding and/or modulation parameters.

15. The method (200) according to claim 14, wherein information about the second set of coding and/or modulation parameters is (a) comprised in the received information about the first set of coding and/or modulation parameters, or (b) is pre-stored in the receiver by an offset with regard to the first set of coding and/or modulation parameters.

16. The method (200) according to claim 14 or 15, wherein the transmission includes at least one reference signal according to a reference signal pattern, wherein the receiver determines the reference signal pattern; wherein the receiver uses the reference signal pattern to determine the grouping of code blocks into first and second group of code blocks.

17. The method (200) according to any of claims 14-16, wherein determining the reference signal pattern comprises receiving information about the reference signal pattern from the transmitter.

18. The method (200) according to any of claims 14-17, wherein the transmission corresponds to one transport block or a part of one transport block.

19. The method (200) according to any of claims 14-17, wherein the transmission is scheduled in a single Downlink Control Information, DCI, message.

20. The method (200) according to any of claims 14-19, wherein a first part of the transmission comprises a first reference signal and the first set of code blocks and a second part of the transmission comprises a second reference signal and the second set of code blocks.

21. The method (200) according to claim 20, further comprising performing (215) a first channel estimation based on the first reference signal as the first reference signal is received.

22. The method (200) according to claim 21, wherein the decoding and/or demodulating (230) of the first set of code blocks is performed also using the first channel estimate.

23. The method (200) according to any of claims 14-22, further comprising performing (240) a second channel estimation based on either the first and the second reference signal or the second reference signal alone.

24. The method (200) according to claim 23, wherein the decoding and/or demodulating (260) of the second set of code blocks is performed also using the second channel estimate.

25. The method (200) according to any of claims 14-24, wherein the transmission comprises one subframe or a plurality of subframes.

26. The method (200) according to any of claims 14-25, wherein the transport block comprises one or more transmissions, wherein a transmission comprises one or more subframes, wherein code blocks are grouped in association with reference signal pattern.

27. The method (200) according to any of claims 14-26, wherein the receiving (210) of, from the transmitter, information about a first set and a second set of coding and/or modulation parameters comprises receiving Downlink Control Information, DCI, message comprising the information about the determined first set and/or second set of coding and/or modulation parameters.

28. The method (200) according to any of claims 14-26, wherein the receiving (210) of, from the transmitter, information about a first set and a second set of coding and/or modulation parameters comprises receiving Radio Resource Control, RRC, information comprising the information about the determined first set and/or second set of coding and/or modulation parameters.

29. The method (200) according to any of claims 14-28, wherein the second coding and/or modulation parameters are first coding and/or modulation parameters combined with offset.

30. A transmitter (400, 500) in a wireless communication network for performing a transmission to a receiver, the transmitter (400, 500) being configured for:
determining a first set and a second set of coding and/or modulation parameters,
transmitting information to the receiver at least about the determined first set of coding and/or modulation parameters,
transmitting a transmission comprising a first set of code blocks, which have been encoded and/or modulated using the first set of coding and/or modulation parameters and a second set of code blocks, which have been encoded and/or modulated using the second set of coding and/or modulation parameters.

31. The transmitter (400, 500) according to claim 30, wherein the information transmitted to the receiver at least about the determined first set of coding and/or modulation parameters also comprises information about the second set of coding and/or modulation parameters.

32. The transmitter (400, 500) according to claim 30 or 31, wherein the transmission includes at least one reference signal in accordance with a reference signal pattern; wherein the grouping of code blocks into first and second group of code blocks are dependent on the reference signal pattern.

33. The transmitter (400, 500) according to any of claims 30-32, wherein the transmission corresponds to one transport block or a part of one transport block.

34. The transmitter (400, 500) according to any of claims 30-33, wherein the transmission is scheduled in a single Downlink Control Information, DCI, message.

35. The transmitter (400, 500) according to any of claims 30-34, wherein a first part of the transmission comprises a first reference signal and the first set of code blocks and a second part of the transmission comprises a second reference signal and the second set of code blocks.

36. The transmitter (400, 500) according to any of claims 30-35, wherein the transmission comprises one subframe or a plurality of subframes.

37. The transmitter (400, 500) according to any of claims 30-36, wherein the first set and the second set of coding and/or modulation parameters are based on an assumed effective channel quality estimation effect at the receiver having one reference signal and having two or more reference signals.

38. The transmitter (400, 500) according to any of claims 30-37, wherein the second set of coding and/or modulation parameters are associated with a higher rate than the first set of coding and/or modulation parameters.

39. The transmitter (400, 500) according to any of claims 30-38, wherein the transmitter (400, 500) is configured for transmitting of information by transmitting the actual determined first set and second set of coding and/or modulation parameters.

40. The transmitter (400, 500) according to any of claims 30-38, wherein the transmitter (400, 500) is configured for transmitting of information by transmitting the determined first set of coding and/or modulation parameters and an offset, wherein the offset is representative of a difference between the determined first set and second set of coding and/or modulation parameters.

41. The transmitter (400, 500) according to any of claims 30-40, wherein the transmitter (400, 500) is configured for transmitting of information by transmitting Downlink Control Information, DCI, message comprising the information about the determined first set and/or second set of coding and/or modulation parameters.

42. The transmitter (400, 500) according to any of claims 30-40, wherein the transmitter (400, 500) is configured for transmitting of information by transmitting Radio Resource Control, RRC, information comprising the information about the determined first set and/or second set of coding and/or modulation parameters.

43. A receiver (600, 700) in a wireless communication network for receiving a transmission, from a transmitter, the receiver (600, 700) being configured for:
receiving, from the transmitter, information about at least a first set of coding and/or modulation parameters,
receiving a first set of code blocks,
decoding and/or demodulating the first set of code blocks using the first set of coding and/or modulation parameters,
receiving a second set of code blocks, and
decoding and/or demodulating the second set of code blocks using a second set of coding and/or modulation parameters.

44. The receiver (600, 700) according to claim 43, wherein information about the second set of coding and/or modulation parameters is (a) comprised in the received information about the first set of coding and/or modulation parameters, or (b) is pre-stored in the receiver by an offset with regard to the first set of coding and/or modulation parameters.

45. The receiver (600, 700) according to claim 43 or 44, wherein the transmission includes at least one reference signal according to a reference signal pattern, wherein the receiver determines the reference signal pattern; wherein the receiver uses the reference signal pattern to determine the grouping of code blocks into first and second group of code blocks.

46. The receiver (600, 700) according to any of claims 43-45, wherein determining the reference signal pattern comprises receiving information about the reference signal pattern from the transmitter.

47. The receiver (600, 700) according to any of claims 43-46, wherein the transmission corresponds to one transport block or a part of one transport block.

48. The receiver (600, 700) according to any of claims 43-46, wherein the transmission is scheduled in a single Downlink Control Information, DCI, message.

49. The receiver (600, 700) according to any of claims 43-48, wherein a first part of the transmission comprises a first reference signal and the first set of code blocks and a second part of the transmission comprises a second reference signal and the second set of code blocks.

50. The receiver (600, 700) according to claim 49, further being configured for performing a first channel estimation based on the first reference signal as the first reference signal is received.

51. The receiver (600, 700) according to claim 50, wherein the decoding and/or demodulating of the first set of code blocks is performed also using the first channel estimate.

52. The receiver (600, 700) according to any of claims 43-51, further being configured for performing a second channel estimation based on either the first and the second reference signal or the second reference signal alone.

53. The receiver (600, 700) according to claim 52, wherein the decoding and/or demodulating of the second set of code blocks is performed also using the second channel estimate.

54. The receiver (600, 700) according to any of claims 43-53, wherein the transmission comprises one subframe or a plurality of subframes.

55. The receiver (600, 700) according to any of claims 43-54, wherein the transport block comprises one or more transmissions, wherein a transmission comprises one or more subframes, wherein code blocks are grouped in association with reference signal pattern.

56. The receiver (600, 700) according to any of claims 43-55, wherein the receiving of, from the transmitter, information about a first set and a second set of coding and/or modulation parameters comprises receiving Downlink Control Information, DCI, message comprising the information about the determined first set and/or second set of coding and/or modulation parameters.

57. The receiver (600, 700) according to any of claims 43-55, wherein the receiving of, from the transmitter, information about a first set and a second set of coding and/or modulation parameters comprises receiving Radio Resource Control, RRC, information comprising the information about the determined first set and/or second set of coding and/or modulation parameters.

58. The receiver (600, 700) according to any of claims 43-57, wherein the second coding and/or modulation parameters are first coding and/or modulation parameters combined with offset.
